(19) United States
(12) Patent Application Publication
(10) Pub. No.: US 2025/0277712 A1
(43) Pub. Date: Sep. 4, 2025

(54) Load Sensing Device for a Hoist

(71) Applicant: Columbus McKinnon Corporation, Getzville, NY (US)

(72) Inventors: Adam Gregory Sanders, Abingdon, VA (US); Charles Vincent Crisp, Kings Mountain, NC (US)

(21) Appl. No.: 18/592,655

(22) Filed: Mar. 1, 2024

(51) Int. Cl. G01L 5/00; G08B 21/18

(52) U.S. Cl. CPC G01L 5/0028; B66D 2700/02; G08B 21/182

(57) ABSTRACT

A load sensing apparatus for use with a material handling device. The load sensing apparatus includes a frame configured to support the material handling device. The frame has an opening defined therein. A top hook has an opening defined therein between a tip and a body portion and has a shank extending from the body portion. At least a portion of the shank passes through the opening in the frame. A fastener is attached to the shank on a side of the frame opposite from the opening in the hook. A force sensor disposed between the fastener and the frame.

### TECHNICAL FIELD

The present invention relates generally to the field of material handling equipment, and more particularly to a load sensing device designed for use with a variety of hoists and a method of using such a system.

### BACKGROUND ART

Sensors for monitoring the load on a hoist in real-time are important for safety reasons. Providing this information to the operator of a hoist in real time may prevent accidents, property damage and injuries. There are prior art systems that include sensors configured to measure the force being applied to a load hook.

There is a need for an improved design for an apparatus for real-time monitoring of a load when a powered or manual hoist is being operated.

### BRIEF SUMMARY OF THE INVENTION

With parenthetical reference to the corresponding parts, portions or surfaces of the disclosed embodiment, merely for the purposes of illustration and not by way of limitation, the present invention meets the above described need by providing a load sensing apparatus (10) for use with a material handling device (100). The load sensing apparatus (10) includes a frame (13) configured to support the material handling device (100). The frame (13) has an opening (67) defined therein. A top hook (61) has an opening (64) defined therein between a tip (70) and a body portion (71) and has a shank (76) extending from the body portion (71). At least a portion of the shank (76) passes through the opening (67) in the frame (13). A fastener (94) is attached to the shank (76) on a side of the frame (13) opposite from the opening (64) in the top hook (61). A force sensor (88) is disposed between the fastener (94) and the frame (13).

In one embodiment, the invention provides a load sensing apparatus (10) for use with a material handling device such as a strap hoist (100), chain hoist or the like. The load sensing apparatus (10) includes a frame (13) configured to support the material handling device. The frame (13) has a top wall (16) with an opening (67) defined therein. A top hook (61) has an opening (62) defined therein between a tip (70) and a body portion (71). The top hook (61) has a shank (76) extending from the body portion (71). The hook (61) has a shoulder (73) formed between a body (71) of the hook (61) and the shank (76). The shank (76) extends through the opening (67) in the top wall (16) such that the shoulder (73) engages with the top surface (85) of the top wall (16). At least a portion of the shank (76) passes through the opening (67) in the top wall (16) of the frame (13).

A fastener (94) is attached to the shank (76) on a side of the top wall (16) opposite from the opening (62) in the hook (61).

A force sensor (88) is disposed between the fastener (94) and the top wall (16).

A display (97) is configured to receive and display a real time measurement of the force on the load hook (52) from the force sensor (88).

The display (97) is mounted on the load sensing apparatus (10).

In one embodiment of the invention, the material handling device is a strap hoist (100) with a pawl and ratchet (40).

In another embodiment, the material handling device is a chain hoist.

In another embodiment, the load sensing apparatus (10) further comprises a load hook attached to the material handling device.

In another embodiment the force sensor (88) has an opening (91) defined therein for receiving the shank (76) therethrough.

In yet another embodiment the force sensor (88) is ring shaped.

Another embodiment provides the shank (76) on the top hook (61) with a set of external threads (79).

In a further embodiment, the top hook (61) has a safety latch (64) disposed thereon.

In another embodiment the force sensor (88) measures the force being applied to the load hook (52).

In yet a further embodiment, the invention includes a control system configured for user programmable limits that trigger an audible alert once a predetermined force level has been detected by the load sensing apparatus (10).

### BRIEF DESCRIPTION OF THE DRAWINGS

FIG. 1 is a front perspective view of the load sensing apparatus of the present invention.

FIG. 2 is a partial front exploded perspective view of the load sensing apparatus of FIG. 1.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

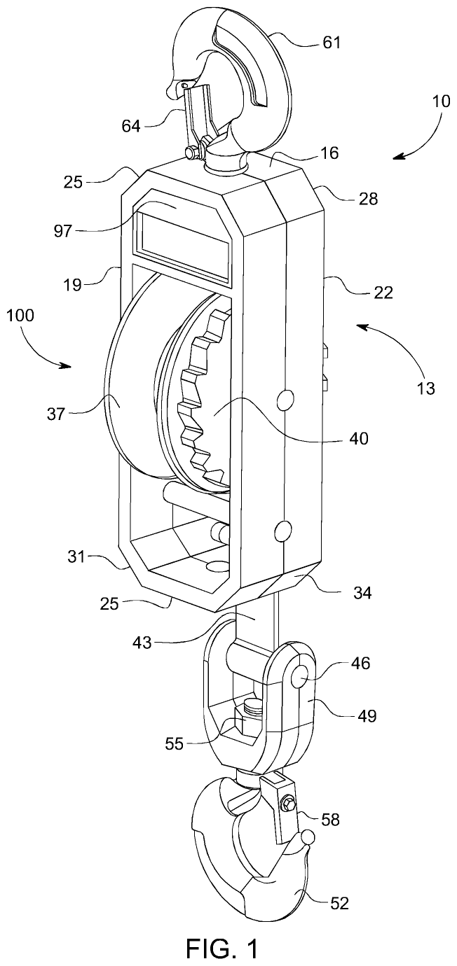

Referring now to the drawings, and more particularly to FIG. 1 thereof, this invention provides a load sensing apparatus 10 for use with a material handling device. A frame 13 has a top wall 16, a pair of side walls 19, 22 and a bottom wall 25. The frame 13 may be constructed of a rigid durable material such as steel or the like. The frame 13 may be provided with angled walls 25, 28, 31, and 34 extending between the side walls 19, 22 and the top wall 16 and bottom wall 25. Other shapes for the frame 13 are also suitable as will be evident to persons of ordinary skill in the art based on this disclosure.

In FIG. 1 the material handling device is a strap hoist with a drum 37 having a ratchet 40 disposed thereon. A strap 43 may be wound around the drum 37. The strap 43 may be connected to a shaft 46 installed in a yoke 49. The ratchet 40 is configured to engage with a pawl (not shown) to provide a lifting engaged mode where the strap 43 can only be wound onto the drum 37 in a single direction during lifting when the pawl engages with the ratchet 40. In a free wheeling mode, where the ratchet 40 is disengaged, the drum 37 can pay out the strap 37. The operation of the pawl and ratchet 40 will be evident to persons of ordinary skill in the art based on this disclosure.

The yoke 49 supports a load hook 52 that is connected to the yoke 49 by a fastener 55. The load hook 52 may be configured such that it is capable of one-hundred eighty degrees of rotation relative to the yoke 49. The load hook 52 may be provided with a pivoting safety latch 58.

The material handling device and load sensing apparatus 10 may be supported from a top hook 61 that is connected to the frame 13 as will be described in detail herein. The top hook 61 may also be provided with a pivoting latch 64.

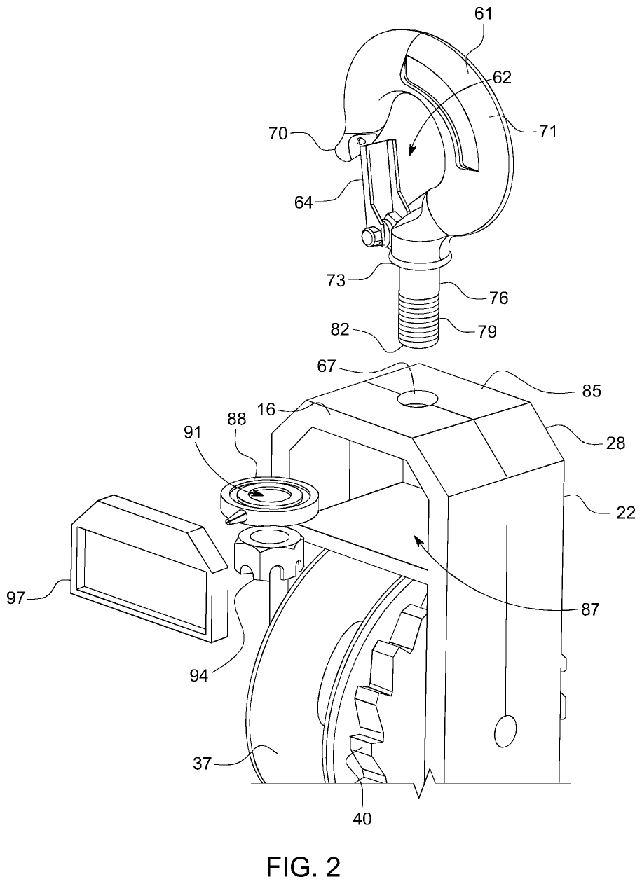

Turning to FIG. 2, the top wall 16 may be provided with an opening 67 defined therethrough. The hook 61 has a tip 70 at one end. At the other end of the hook 61 a shoulder 73 may be formed above the shank 76. The shank 76 may be provided with a set of threads 79. The threads 79 may extend from a distal end 82 of the shank 76 upward for a portion of the length of the shank 76.

In use, the shank 76 is inserted through the opening 67 until the shoulder 73 engages with the top surface 85 of the top wall 16. With the shoulder 73 engaging the top surface 85, the shank 76 extends downward into an open space created in the frame 13.

A force sensor 88 may be ring-shaped and may have a central opening 91 defined therein. The central opening 91 may be configured to receive the shank 76 therethrough.

A nut 94 may be provided with internal threads configured to mate with the external threads 79 on the shank 76. The force sensor 88 is captured between the nut 94 and the top wall 16 of the frame 13.

A display 97 may be configured to show an integrated real-time value for the force resulting from a load applied to the load hook 52.

The hoist 100 (FIG. 1) may be manually or power operated. The hoist 100 may also be a strap hoist as shown or a chain hoist would also be suitable.

The present invention contemplates that many changes and modifications may be made. Therefore, while the presently-preferred form of the load sensing apparatus has been shown and described, and several modifications and alternatives discussed, persons skilled in this art will readily appreciate that various additional changes and modifications may be made without departing from the spirit of the invention, as defined and differentiated by the following claims.

1. A load sensing apparatus for use with a material handling device, the load sensing apparatus, comprising:
a frame configured to support the material handling device, the frame having an opening defined therein;
a top hook having an opening defined therein between a tip and a body portion and having a shank extending from the body portion;
at least a portion of the shank passing through the opening in the frame;
a fastener attached to the shank on a side of the frame opposite from the opening in the hook.
a force sensor disposed between the fastener and the frame.

2. The apparatus as set forth in claim 1, further comprising a shoulder formed between a body of the hook and the shank.

3. The apparatus as set forth in claim 2, wherein the shank extends through the opening in the frame such that the shoulder engages with a surface of the frame.

4. The apparatus as set forth in claim 1, wherein the material handling device is a strap hoist with a pawl and ratchet.

5. The apparatus as set forth in claim 1, further comprising a display configured to receive and display a measurement from the force sensor, the display mounted on the load sensing apparatus.

6. The apparatus set forth in claim 1, wherein the material handling device is a chain hoist.

7. The apparatus set forth in claim 1, wherein the load sensing apparatus further comprises a load hook attached to the material handling device.

8. The apparatus set forth in claim 1, wherein the force sensor has an opening defined therein for receiving the shank therethrough.

9. The apparatus set forth in claim 1, wherein the force sensor is ring shaped.

10. The apparatus set forth in claim 1, wherein the shank on the top hook has a set of external threads disposed thereon.

11. The apparatus set forth in claim 1, wherein the top lock has a safety latch disposed thereon.

12. The system set forth in claim 7, wherein the force sensor measures the force being applied to the load hook.

13. The apparatus set forth in claim 1, further comprising a control system configured for user programmable limits that trigger an alert once a predetermined force level has been detected by the load sensing apparatus.

14. A load sensing apparatus for use with a material handling device, the load sensing apparatus, comprising:
a frame configured to support the material handling device, the frame having a wall with an opening defined therein;
a top hook having an opening defined therein between a tip and a body portion and having a shank extending from the body portion, the top hook having a shoulder formed between a body of the top hook and the shank, the shank extending through the opening in the wall;
at least a portion of the shank passing through the opening in the wall of the frame;
a fastener attached to the shank on a side of the wall opposite from the opening in the hook.
a force sensor disposed between the fastener and the wall;
a display configured to receive and display a measurement from the force sensor, the display mounted on the load sensing apparatus.

15. The apparatus as set forth in claim 14, wherein the shank extends through the opening in the wall of the frame such that the shoulder engages with the wall.

16. The apparatus as set forth in claim 14, wherein the material handling device is a strap hoist with a pawl and ratchet.

17. A load sensing apparatus for use with a material handling device, the load sensing apparatus, comprising:
a frame configured to support the material handling device, the frame having a top wall with an opening defined therein;
a top hook having an opening defined therein between a tip and a body portion and having a shank extending from the body portion, the top hook having a shoulder formed between a body of the top hook and the shank, the shank extending through the opening in the top wall;
at least a portion of the shank passing through the opening in the top wall of the frame;
a fastener attached to the shank on a side of the top wall opposite from the opening in the hook.
a force sensor disposed between the fastener and the top wall;
a display configured to receive and display a measurement from the force sensor, the display mounted on the load sensing apparatus;
a load hook attached to the material handling device; and,
a control system configured for user programmable limits that trigger an alert once a predetermined force level has been detected by the load sensing apparatus.

18. The apparatus of claim 17, wherein the control system is programmed to compare a load weight calculated by the force sensor and a rated weight capacity for the material handling device.

19. The apparatus as set forth in claim 17, wherein the shank extends through the opening in the top wall of the frame such that the shoulder engages with the top wall.

20. The apparatus as set forth in claim 17, wherein the material handling device is a strap hoist with a pawl and ratchet.
